(19) United States
(12) Patent Application Publication
(10) Pub. No.: US 2026/0093743 A1
(43) Pub. Date: Apr. 2, 2026

(54) METHOD AND SYSTEM FOR ESTABLISHING TEXT-VECTORIZATION DATABASE, AND APPLICATION SYSTEM

(71) Applicant: GOLDEN SMART HOME TECHNOLOGY CORP., HSINCHU CITY (TW)

(72) Inventors: CHIH-CHE LIN, Hsinchu City (TW); Ting-Wei Ho, Keelung City (TW)

(21) Appl. No.: 19/021,192

(22) Filed: Jan. 15, 2025

(30) Foreign Application Priority Data
Sep. 30, 2024 (TW) 113137233

(51) Int. Cl. G06F 16/334; G06F 40/20

(52) U.S. Cl. CPC G06F 16/3347; G06F 40/20

(57) ABSTRACT

A method and a system for establishing a text-vectorization database, and an application system. The method includes first obtaining a textual content, dividing the textual content to form sections, analyzing, through a small language model, the sections and obtaining one or more keywords in each of the sections. Then, texts in each of the sections are combined with the one or more keywords corresponding to the sections to form new sections combined with the one or more keywords. Vectorization is executed on the new sections to form vectorized sections, and the text-vectorization database is established.

### CROSS-REFERENCE TO RELATED PATENT APPLICATION

This application claims the benefit of priority to Taiwan Patent Application No. 113137233, filed on Sep. 30, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a textual content vectorization processing technology, and more particularly to a method and a system that combines textual contents of sections and keywords and then performs vectorization to establish a text-vectorization database, and an application system.

### BACKGROUND OF THE DISCLOSURE

In existing natural language processing (NLP) technology, words are combined into sentences and sentences are then combined into sections (e.g., paragraphs) in a textual content. These words that cannot be understood by machines are processed through vectorization and converted into mathematical representations, such as an embedding vector, thereby allowing the natural language processing technology to query and compare these words and sentences. One of the applications is a service that uses natural language to conduct dialogue, in which systems running natural language processing models can perform vectorization processing on contents input by a user.

FIG. 1 shows an example of a process of using conventional technology to implement text vectorization to implement natural language dialogue.

When performing text vectorization processing, the input textual content (i.e., a textual content 100) is divided into sections to form a first textual content section 101, a second textual content section 102, and a third textual content section 103. The vector algorithm is executed segmentally to obtain the vector value of each of the sections, such as a first vector 111, a second vector 112, and a third vector 113. Therefore, the textual content becomes a collection of word vectors and is then stored in a database 115.

In a system that provides natural language dialogue, a user input question 105 is received, and a vector algorithm is executed for vectorization of the user input question 105 to form a fourth vector 114. The system calculates a vector comparison 107, that is, calculating a similarity in a vector space with the word vectors generated by each text in the database 115, and the word with the highest similarity can be obtained. That is, a result 109 of the word or the section most similar to the user input question 105 can be obtained as an answer in response to a question input by the user.

However, a conventional issue is that the accuracy of similar sections obtained by using vector algorithms cannot be effectively improved. Therefore, for large language models, an accurate answer is unable to be immediately provided in each knowledge field, which hinders the further development of natural language processing.

### SUMMARY OF THE DISCLOSURE

In order to improve the accuracy of obtaining similar sections in natural language processing, the present disclosure provides a method for establishing a text-vectorization database. The method is executed in a server, and includes the following steps. First, a textual content is obtained and the textual content is divided into a plurality of sections. A small language model is then used to analyze the sections and obtain one or more keywords in each of the sections. Then, texts are combined in each of the plurality of sections with the one or more keywords corresponding to the plurality of sections to form a plurality of new sections combined with the one or more keywords, and then a vectorization is executed on the plurality of new sections to form a plurality of vectorized sections, so as to form the text-vectorization database.

Further, in the process of forming the plurality of new sections combined with the one or more keywords, the one or more keywords are combined to a position before or after a corresponding one of the plurality of sections. Alternatively, a weight is assigned to each of the one or more keywords in each of the plurality of sections, and based on the weight of each of the one or more keywords, each of the one or more keywords is combined with the texts in each of the plurality of sections, thereby enhancing the importance of the keywords in the textual content.

In each of the sections, a corresponding weight can be assigned according to a number of times each of the keywords appears; or an importance of each of the keywords can be determined by comparing with a word base to assign a corresponding weight to the keyword.

Further, the server includes an output and input interface for receiving a dialogue content transmitted from a terminal device, and the dialogue content undergoes vectorization to form a vectorized dialogue content. A similarity is calculated with the plurality of vectorized sections of the text-vectorization database to determine a reply in response to the dialogue content.

According to one embodiment of the system for establishing a text-vectorization database, the system includes a server system. The server system includes a textual content processing module, a keyword acquisition module, a vectorization module, and a text-vectorization database. According to the method run in the system, a textual content is obtained through the textual content processing module, and the textual content is divided into a plurality of sections. The plurality of sections are analyzed through the keyword acquisition module, and one or more keywords in each of the plurality of sections are obtained. The textual content processing module combines texts in each of the plurality of sections with the one or more keywords corresponding to the plurality of sections to form a plurality of new sections combined with the one or more keywords. The vectorization module is used to execute vectorization on the plurality of new sections to form a plurality of vectorized sections, so as to form the text-vectorization database.

Further, the textual content includes contents related to a knowledge field, and the text-vectorization database formed based on the textual content implements a knowledge base for the knowledge field.

Furthermore, the server system includes an output and input interface. When a dialogue content transmitted from a terminal device and related to the knowledge field is received, the dialogue content undergoes vectorization to form a vectorized dialogue content, and a similarity is calculated with the plurality of vectorized sections of the text-vectorization database to obtain a reply in response to the dialogue content.

The present disclosure further provides an application system, and the supplication system includes a small language model application management platform. The small language model application management platform provides a textual content service of an external system and integrates the textual content service to the application system through the server-side application programming interface, determines a channel to obtain a textual content of the external system through the channel selector, and processes the textual content obtained from the external system to form the text-vectorization database through the method for establishing the text-vectorization database. The small language model application management platform processes a prompt received from a terminal device through the prompt management module. After the prompt undergoes vectorization, a similarity is calculated with the plurality of vectorized sections of the text-vectorization database to obtain a reply in response to the dialogue content.

Furthermore, the application system executes a retrieval augmented generation agent (RAG agent) to introduce multiple textual contents obtained from multiple external systems into multiple small language models in the application system, such that a text-vectorization database formed based on multiple textual contents can implement multiple knowledge bases for multiple knowledge fields.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is an example of the process of running text vectorization to realize natural language dialogue in the existing technology;

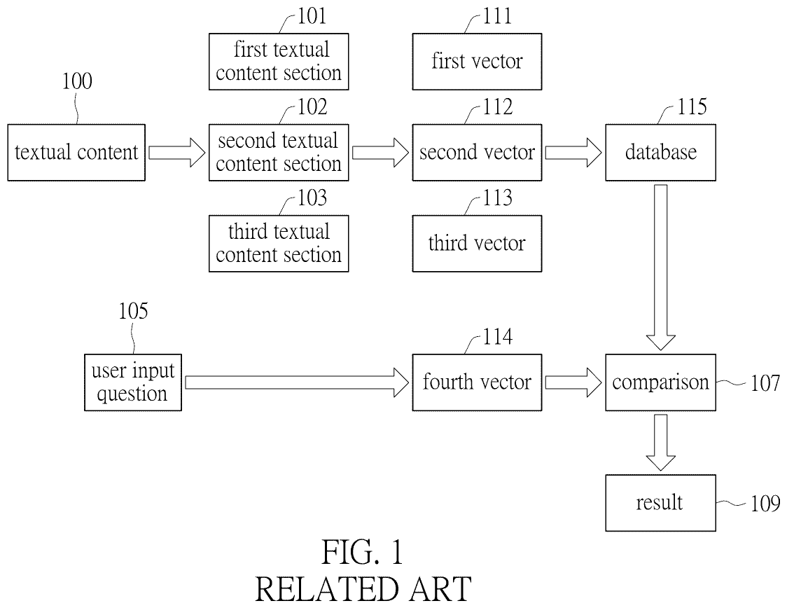

FIG. 2 is a schematic diagram of a system for establishing a text-vectorization database;

FIG. 3 is a flowchart of a method for establishing the text-vectorization database;

FIG. 4 is a flowchart of using the text-vectorization database to respond to a content input by a user; and

FIG. 5 is a schematic diagram of an application system that provides services by using the text-vectorization database.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure provides a method and a system for establishing a text-vectorization database, and an application system, in which the accuracy of processing similarity comparison by using natural language is increased by enhancing the intensity of keywords among words. One embodiment of enhancing the intensity of keywords is to directly combine textual contents of sections to determine the keywords of the section, or to assign corresponding weights to the keywords through calculation, so as to increase the intensity of the keywords in the combined new section according to the weights. Therefore, the text-vectorization database established based on the new sections that have undergone vectorization can improve the accuracy of querying similar words.

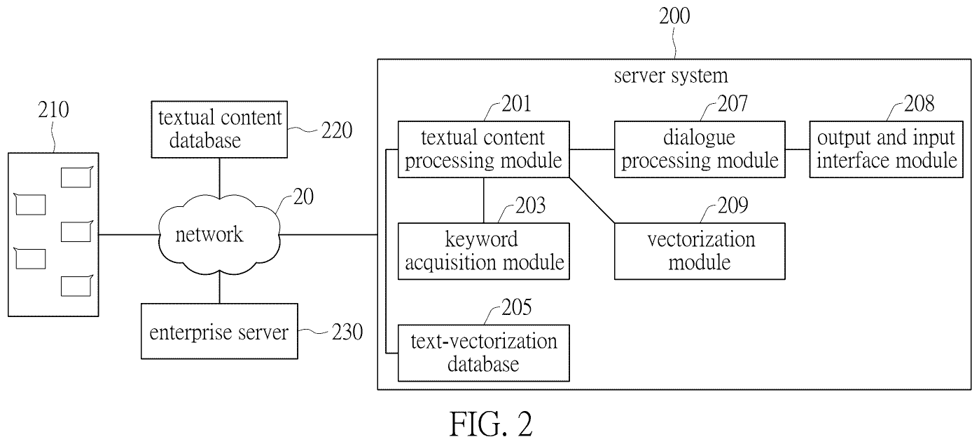

FIG. 2 is a schematic diagram of a system for establishing a text-vectorization database.

The figure shows a server system 200 that executes a method for establishing a text-vectorization database. The server system 200 uses a cooperation of hardware and software to implement a textual content processing module 201, a keyword acquisition module 203, and a vectorization module 209. The server system 200 may further include a dialogue processing module 207 and an output and input interface module 208 for processing subsequent dialogue contents. It should be noted that, the textual content processed by the server system 200 includes contents related to a specific knowledge field, and a text-vectorization database 205 formed based on the textual content can implement a knowledge base in this knowledge field.

The textual content processing module 201 processes the received textual content, including dividing the textual content into a plurality of sections, and analyzing the plurality of sections through the keyword acquisition module 203 to obtain one or more keywords in each of the plurality of sections. Then, one or more keywords in each of the plurality of sections are combined with the textual content of the corresponding one of the plurality of sections to form multiple new sections combined with the one or more keywords. Afterwards, a vectorization algorithm in the vectorization module 209 is used to perform vectorization on the plurality of new sections to form a plurality of vectorized sections. After storing the plurality of vectorized sections, the text-vectorization database 205 is formed.

The server system 200 can obtain a textual content from a specific textual content database 220 through a network 20; alternatively, after an enterprise provides the textual content, the server system 200 can establish a text-vectorization database according to the requirements of the enterprise. Then, a text-vectorization database formed based on multiple textual contents can implement multiple knowledge bases in multiple knowledge fields and provide access for an enterprise server 230 to establish internal knowledge base applications.

Further, the server system 200 provides a natural language dialogue service by using the text-vectorization database 205 established based on the textual content. A user can query data or dialogue by using natural language through the application program executed on a terminal device 210 via the network 20. For example, the text-vectorization database 205 built in the server system 200 can be queried through the enterprise server 230. The text-vectorization database 205 can be used as an enterprise knowledge base, thereby providing internal knowledge management and query applications of the enterprise, or the enterprise can provide natural language dialogue services in specific knowledge fields such as customer service applications.

According to one embodiment, the server system 200 includes an output and input interface module 208 to implement an output and input interface for transmitting messages to and from the terminal device 210. The output and input interface module 208 can receive a dialogue content related to a certain knowledge field from the terminal device 210, and the dialogue content is then processed by the dialogue processing module 207. Here, the server system 200 obtains the dialogue content through the output and input interface module 208. The dialogue content undergoes vectorization by the vectorization module 209 to form a vectorized dialogue content. The dialogue processing module 207 calculates a similarity by communicating with multiple vectorized sections in the knowledge base in a specific knowledge field to perform similarity comparison and calculate a word having a highest similarity to determine a reply in response to the dialogue content.

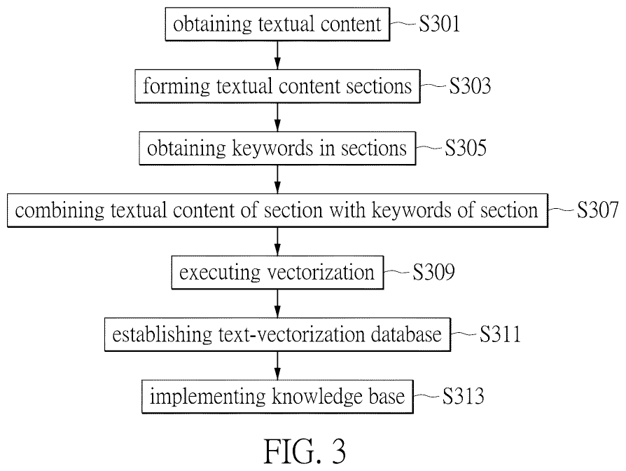

Next, reference is made to FIG. 3, and FIG. 3 is a flowchart of a method for establishing the text-vectorization database.

In the method for establishing the text-vectorization database, a textual content in a specific knowledge field is first obtained. As shown in the system of FIG. 2, the textual content can be a file obtained from a textual content database, a text file provided by the enterprise for a specific knowledge field, and may be a voice file that can be converted into texts (step S301).

Next, according to the embodiment, if the file is large, or for specific reasons, the file can be formed into multiple textual content sections, and the subsequent similarity comparison can be smoother through pre-processing of multiple sections (step S303). The ways of dividing the textual content include: arbitrarily forming multiple sections by using software; dividing the textual content into a plurality of sections based on the words recorded in a word base; dividing the textual content according to punctuation marks in the sections; and dividing the textual content based on semantics derived from analyzing the textual content by using a natural language model. One of the goals of dividing the textual content into the plurality of sections is to increase the accuracy of keyword determination and to effectively express the meaning of each of the sections.

Afterwards, one or more keywords in each of the sections are obtained (step S305). According to one embodiment, a small language model (SLM) can be used to analyze the plurality of sections according to the characteristics of the knowledge field to which the textual content belongs, determine one or more keywords of each of the sections, and then combine the textual content of the sections with one or more keywords of the corresponding section to form a plurality of new sections combined with the keywords (step S307).

Here, in the step of combining the text of each of the sections with one or more keywords corresponding to the section, texts without actual meaning can be excluded according to the word base, so as to obtain meaningful words in the section. One way of determining keywords can be based on a number of times each of the words appears in a section, that is, one or more keywords in each of the sections can be determined based on a word frequency. In addition, a trained text model that can determine meaningful words can also be used to determine keywords.

It should be noted that an original textual content of each of the sections can already be analyzed to obtain one or more keywords. The method provided in the present disclosure is to enhance the strength of keywords during comparison. The method is implemented by combining an original content of each of the sections with one or more keywords obtained through analysis. For example, one or more keywords are added to a position before the original section, a position after the original section, or a specific position of the original section, thereby increasing the number of times of the keywords appearing in the section. Therefore, in a similarity calculation and comparison performed subsequently, the accuracy of comparison can be improved due to the increase in the number of appearances of keywords.

According to one embodiment, the process of combining the textual content of the section with one or more keywords may also include assigning a weight to each of the keywords according to an importance of each of the keywords. According to one embodiment, text models in related knowledge fields are used to determine the importance of each of the keywords in the textual content of the section, and the weight assigned to each of the keywords in each of the sections can be determined based on the importance. In another embodiment, in each of the sections, the higher the number of times each of the keywords appears in each of the sections is, the higher the importance the keyword has. Therefore, a corresponding weight can be assigned to each of the keywords according to the number of times each of the keywords appears. In another embodiment, the system can compare the word base provided by each of the knowledge fields to determine the importance of each of the keywords in the textual content of the knowledge fields, so as to assign corresponding weights. Afterwards, the keywords are combined to the corresponding texts of the section according to the weight of each of the keywords. For example, if a weight of a keyword is set to be 1, the keyword is added once to the textual content of the section; if the weight of another keyword is set to be 2, the keyword is added twice to the section.

When multiple new sections are obtained based on the above manners of combining keywords, vectorization is then performed on the multiple new sections, and the texts of the sections are converted into numerical values for performing similarity calculations to form multiple vectorized sections (step S309). After the vectorized sections are stored into a storage device of the server system, a text-vectorization database is established (step S311). If the text-vectorization database is established for the textual content in a specific knowledge field, a knowledge base in that knowledge field can be implemented (step S313).

It should be noted that in the process of combining one or more keywords in each of the textual content of the sections to form new sections, one or more keywords can be combined to positions before or after the corresponding section. A detailed implementation can be referred to in the following descriptions.

The textual content is divided into multiple sections. Each of the sections (Pᵢ) is composed of multiple words (tᵢ₁ to tᵢₙ), which can be expressed as Pᵢ={tᵢ₁, tᵢ₂, tᵢ₃, . . . , tᵢₙ}. According to the method provided in the above-mentioned embodiment, one or more keywords (Tᵢ₁ to Tᵢₘ) of each of the sections are determined by applying a specific text model, based on the number of times of appearance of each of the words, or based on a word base in a specific knowledge field. A keyword set (Qᵢ) in each of the sections can be expressed as Qᵢ={Tᵢ₁, Tᵢ₂, Tᵢ₃, . . . , Tᵢₘ}. The variable m in the above-mentioned expression should be less than or equal to n (i.e., m≤n).

Afterwards, the combination of the textual content of the sections with one or more keywords can be achieved by combining the keywords into the sections according to the weight of each of the keywords. For example, adding one or more keywords after the textual content of a section can be expressed as {Pᵢ+Qᵢ}; adding one or more keywords before the textual content of the section can be expressed as {Qᵢ+Pᵢ}; alternatively, a corresponding weight (Yᵢ) is assigned to each of the keywords, each of the keywords is combined to the section according to the weight of the keywords, and the new section can be expressed as {Pᵢ+Qᵢ Yᵢ} or {QᵢYᵢ+Pᵢ}.

During the process, multiple sections (Pᵢ), keyword sets (Qᵢ), and new sections after combination ({Pᵢ+QᵢYᵢ} or {QᵢYᵢ+Pᵢ}) in the textual content that are obtained are stored in the storage device of the server system. Then, a vectorization calculation is executed, and vectorization is executed on each of the sections (Pᵢ) to form vectorized sections represented as Vₚᵢ.

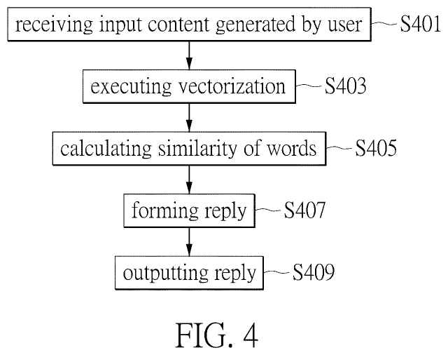

After a text-vectorization database formed by the new sections is established, the text-vectorization database can be used in a variety of natural language processing applications. For example, a natural language is used to respond to a dialogue content provided by the user through the application, and reference can be made to FIG. 4, which is a flowchart of using the text-vectorization database to respond to a content input by a user.

The server that executes the method for establishing a text-vectorization database includes an output and input interface, and the dialogue service provided by the server receives an input content generated by a user operation of the terminal device through the output and input interface (step S401). According to the above-mentioned expressions, a piece of input content includes multiple words (t_{q1} to t_{qn}) that can be expressed as S_{q}={t_{q1}, t_{q2}, t_{q3}, . . . , t_{qn}}. Next, vectorization is executed on multiple words in the input content, and the dialogue content undergoes vectorization to form a vectorized dialogue content that can be expressed as V_{sq} (step S403).

Then, the vectorized dialogue content (V_{sq}) is compared with the vectorized multiple vectorized sections (Vₚᵢ) in the text-vectorization database to calculate a similarity of words (step S405). Calculating similarity through vectorized numerical values is to calculate the cosine value of two vectors, and the cosine value is between −1 and 1. The larger the cosine value is, the higher the similarity is. Since the text-vectorization database records the text-vectorization of the new section obtained by combining keywords, and the new section has enhanced the weight of the keywords, a more accurate reply can be obtained (step S407) to be output and used to respond to the input content of the user (step S409).

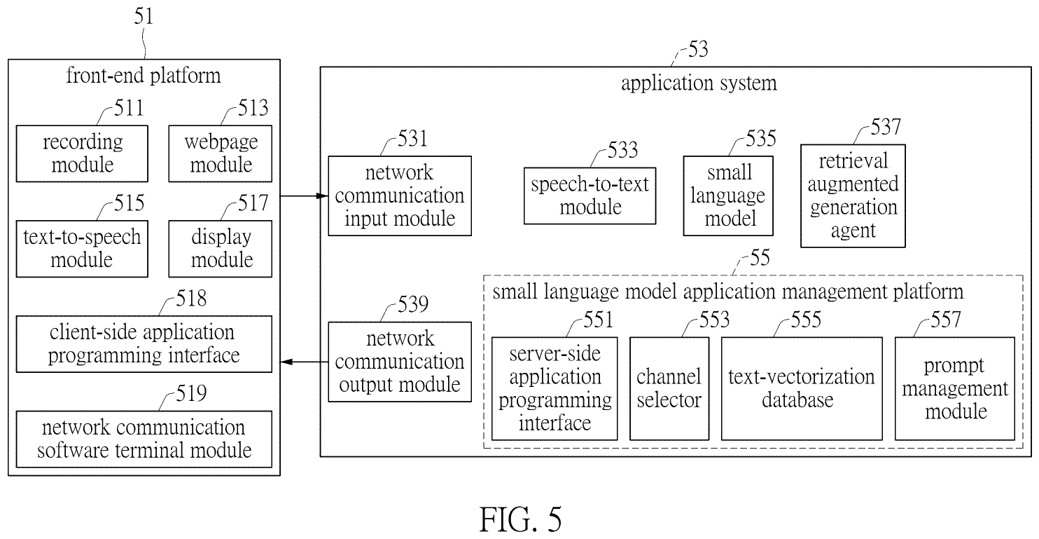

FIG. 5 is a schematic diagram of an application system that provides services by using the text-vectorization database established above by combining the new sections obtained by combining keywords.

An application system 53 shown in the figure can be implemented by cooperation of software and hardware in the computer system. The implemented modules include a network communication input module 531 that processes data transmitted by the user accessing the application system 53 through the network, and a network communication output module 539 that processes and outputs data. The application system 53 provides a speech-to-text module 533 that allows the user to generate the input content with speech and convert the input content into text, and can provide a small language model (SLM) 535 for dialogue services in various knowledge fields. According to one embodiment, the application system 53 can run one or more small language models, each of the small language models is used to process textual contents provided by an external system in a specific knowledge field, so as to analyze multiple sections in the textual content to determine one or more keywords of each of the sections based on the knowledge field.

The application system 53 further provides a retrieval augmented generation agent (RAG agent) 537 to connect the retrieval augmented generation (RAG) service in series. The RAG agent is responsible for implementing the aforementioned query process on the text-vectorization database, and can also execute numerical calculations and other actions during the implementation process to perform necessary pre-processing for questions input by the user. For example, the application system 53 can import multiple texts obtained from multiple external systems into multiple ones of the small language models 535 in the application system, so as to form a text-vectorization database 555 based on the multiple texts to implement multiple knowledge bases of multiple knowledge fields. In this way, an RAG service can be implemented through the text-vectorization database 555 established for a specific knowledge field in a small language model application management platform 55 as provided in the application system 53.

One of the main features of the application system 53 is to provide the small language model application management platform 55 that includes a server-side application programming interface (API) 551, a channel selector 553, a text-vectorization database 555, and a prompt management module 557. The small language model application management platform 55 provides the textual content service of the external system through the server-side application programming interface 551 and integrates the textual content into the application system 53. The channel selector 553 is used to determine a channel to obtain the textual content from the external system, and the prompt management module 557 can process a prompt received from the terminal device. The prompt may be vectorized and then the similarity is calculated with multiple vectorized sections in the text-vectorization database 555 to obtain a reply in response to the prompt.

Furthermore, through a front-end platform 51, the application system 53 allows end users to access services provided by the application system 53. The front-end platform 51 is such as an application program or a computer device running on the terminal device, and the application system 53, through the front-end platform 51, provides services such as a natural language customer service or a knowledge base query service of an enterprise, in which relevant processes are as the following descriptions.

The services provided by the application system 53 are as listed below.

The front-end platform 51 executes a client-side application programming interface 518, such that the front-end platform 51 can access services provided by the application system 53 through a specific application programming interface, and the services are such as allowing an enterprise to establish an online customer service center. The front-end platform 51 allows users to access the application system 53 through a network communication software terminal module 519 for the enterprise to conduct customer services through instant text and voice messaging.

The user operates a webpage interface provided by a webpage module 513 in the front-end platform 51, and a display module 517 displays an online customer services provided by the enterprise. The front-end platform 51 includes a recording module 511 to record a voice content generated by the user through the online customer service on the webpage interface, and the voice content is such as the user calling the customer service center of the enterprise. The front-end platform 51 then performs format conversion through the client-side application interface 518 and establishes a connection with the application system 53 through the network communication software terminal module 519 to transmit a generated voice signal to the application system 53.

The application system 53 receives the voice signal through the network communication input module 531, processes the voice signal through the server-side application programming interface 551 of the small language model application management platform 55, and then converts the voice signal into a text prompt by using the speech-to-text module 533. The retrieval augmented generation agent 537 is used to implement the service of retrieval augmented generation. The text prompt is first processed by the prompt management module 557 via vectorization processing, and the similarity is calculated with multiple vectorized sections in the text-vectorization database 555, so as to obtain a reply in response to the prompt. Afterwards, the content obtained by querying the text-vectorization database 555 can be processed by a small language model 535 to generate a reply content in natural language, and then the reply content is sent back to the front-end platform 51 through the network communication output module 539. Then, in the front-end platform 51, a text-to-speech module 515 can convert the text of the reply content into a speech that is then played, or the text of the reply content can be displayed on the user interface through the display module 517.

In another embodiment, the application system 53 establishes a knowledge base for the enterprise. An end user operates the front-end platform 51 to provide the webpage interface through the webpage module 513, and the display module 517 is used to provide a screen of a user interface to the end user, such that the end user can operate the webpage to generate an input content for querying a specific knowledge field. After the input content is transmitted to the application system 53 through the network, the input content is analyzed and quantified through the small language model 535 in a specific knowledge field, such that the text-vectorization database 555 is queried. An answer is obtained according to similarity comparison, and the answer can be accurately determined according to the input content of the end user, and the reply content displayed on the webpage is similarly generated through the webpage module 513.

In summary, according to the above-described embodiments of the method, system, and application system for establishing a text-vectorization database, when the textual content is obtained, the importance of the keywords in the sections is enhanced through a new combination of the textual content of the sections and the keywords. The database formed by a vectorization of the combination of the textual content of the sections and the keywords may accurately provide answers to a content input by the user through vectorization calculation and similarity comparison.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for establishing a text-vectorization database, executed in a server, the method comprising:
obtaining a textual content and dividing the textual content into a plurality of sections;
analyzing the plurality of sections and obtaining one or more keywords in each of the plurality of sections;
combining texts in each of the plurality of sections with the one or more keywords corresponding to the plurality of sections to form a plurality of new sections combined with the one or more keywords;
executing vectorization on the plurality of new sections to form a plurality of vectorized sections; and
storing the plurality of vectorized sections to form the text-vectorization database.

2. The method according to claim 1, wherein, in the process of forming the plurality of new sections combined with the one or more keywords, the one or more keywords are combined to a position before or after a corresponding one of the plurality of sections.

3. The method according to claim 1, wherein, in the process of forming the plurality of new sections combined with the one or more keywords, a weight is assigned to each of the one or more keywords in each of the plurality of sections, and based on the weight of each of the one or more keywords, each of the one or more keywords is combined with the texts in each of the plurality of sections.

4. The method according to claim 1, wherein the server executing the method for establishing the text-vectorization database includes an output and input interface for receiving a dialogue content transmitted from a terminal device, and the dialogue content undergoes vectorization to form a vectorized dialogue content, and wherein a similarity is calculated with the plurality of vectorized sections of the text-vectorization database to obtain a reply in response to the dialogue content.

5. The method according to any one of claims 1 to 4, wherein the plurality of sections are analyzed through a small language model to determine the one or more keywords of each of the plurality of sections.

6. A system for establishing a text-vectorization database, comprising:
a server system including a textual content processing module, a keyword acquisition module, a vectorization module, and a text-vectorization database;
wherein a textual content is obtained through the textual content processing module, and the textual content is divided into a plurality of sections; wherein the plurality of sections are analyzed through the keyword acquisition module, and one or more keywords in each of the plurality of sections are obtained; wherein the textual content processing module combines texts in each of the plurality of sections with the one or more keywords corresponding to the plurality of sections to form a plurality of new sections combined with the one or more keywords; wherein the vectorization module is used to execute vectorization on the plurality of new sections to form a plurality of vectorized sections and the plurality of vectorized sections are stored to form the text-vectorization database.

7. The system according to claim 6, wherein in the process of forming the plurality of new sections combined with the one or more keywords, the one or more keywords are combined to a position before or after a corresponding one of the plurality of sections.

8. The system according to claim 6, wherein, in the process of forming the plurality of new sections combined with the one or more keywords, a weight is assigned to each of the one or more keywords in each of the plurality of sections, and based on the weight of each of the one or more keywords, each of the one or more keywords is combined with the texts in each of the plurality of sections.

9. The system according to any one of claims 6 to 8, wherein the textual content includes contents related to a knowledge field, and the text-vectorization database formed based on the textual content implements a knowledge base for the knowledge field.

10. The system according to claim 9, wherein the server system includes an output and input interface for receiving a dialogue content transmitted from a terminal device and related to the knowledge field, and the dialogue content undergoes vectorization to form a vectorized dialogue content, and wherein a similarity is calculated with the plurality of vectorized sections of the text-vectorization database to obtain a reply in response to the dialogue content.

11. An application system, comprising:
a small language model application management platform including a server-side application programming interface, a channel selector, a text-vectorization database, and a prompt management module;
wherein the small language model application management platform provides a textual content service of an external system and integrates the textual content service to the application system through the server-side application programming interface, determines a channel to obtain a textual content of the external system through the channel selector, and processes the textual content obtained from the external system to form the text-vectorization database through the method for establishing the text-vectorization database as claimed in claim 1; wherein the small language model application management platform processes a prompt received from a terminal device through the prompt management module, and wherein, after the prompt undergoes vectorization, a similarity is calculated with the plurality of vectorized sections of the text-vectorization database to obtain a reply in response to the dialogue content.

12. The application system according to claim 11, wherein a plurality of small language models are run in the application system; wherein each of the plurality of small language models processes the textual content related to a knowledge field and provided by the external system, and analyzes the plurality of sections of the textual contents to determine the one or more keywords of each of the plurality of sections based on the knowledge field; and wherein each of the plurality of small language models is used to generate the reply in a natural language after processing a content obtained by querying the text-vectorization database.
